(19) United States
(12) Patent Application Publication
(10) Pub. No.: US 2009/0000714 A1
(43) Pub. Date: Jan. 1, 2009

(54) Pneumatic Tire and Tire Assembly

(75) Inventor: Masaaki Ohara, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/138,576

(22) Filed: Jun. 13, 2008

Related U.S. Application Data
(60) Provisional application No. 60/946,856, filed on Jun. 28, 2007.

(51) Int. Cl. B60C 5/22

(52) U.S. Cl. 152/340.1

(57) ABSTRACT

The pneumatic tire includes an outer tire installed such that a bead portion is inscribed in a rim flange, and an inner tire inserted inside the outer tire and installed such that a bead portion is inscribed in the bead portion of the outer tire. A plurality of protrusions are provided in an annular outer side wall surface region extending in an outer side in a tire diametrical direction from a bead heel of the inner tire so as to be differentiated in the positions in the tire diametrical direction and overlap with one another when seen in a tire circumferential direction, and a ventilation path for feeding an air supplied to a portion near the bead heel into an air chamber is formed between the protrusions in a state where the outer side wall surface region is inscribed in the bead portion.

### BACKGROUND OF THE INVENTION

1. Field of the Invention

The present invention relates to a double structure pneumatic tire in which an inner tire is inserted inside an outer tire, and a tire assembly provided with the pneumatic tire.

2. Description of the Related Art

A conventional example of this kind of pneumatic tire is shown in FIGS. 8 to 10. The pneumatic tire has a double structure including an outer tire 6 structured such that a bead portion 61 is inscribed in a rim flange 8a, and an inner tire 7 inserted inside the outer tire 6 and structured such that a bead portion 71 is inscribed in the bead portion 61 of the outer tire 6. Air chambers 9A and 9B individually filled with air are formed at an inner side and an outer side of the inner tire 7, and the airtightness of the chambers is independently secured.

In the pneumatic tire mentioned above, even in the case where an internal pressure of the outer tire 6 is lost due to an external damage or the like, the pneumatic tire is supported by an internal pressure of the inner tire 7. Accordingly, it is possible to suppress rapid reduction in steering stability. Therefore, as disclosed in U.S. Pat. Nos. 4,995,438, 5,246,050, 5,273,093, and 6,688,359, the pneumatic tire is useful as a racing tire.

It is possible to fill the air in the air chamber 9A by using a rim valve 81 provided in a rim 8. On the other hand, it is necessary to fill the air in the air chamber 9B through a portion between the bead portion 71 of the inner tire 7 and the bead portion 61 of the outer tire 6 by using a rim valve 82 provided in a bead seat 8b. Accordingly, when the bead portion 71 of the inner tire 7 is made inscribed in the bead portion 61 of the outer tire 6 in a close contact state, it becomes impossible to feed the air into the air chamber 9B.

Accordingly, in the conventional pneumatic tire, a bulge portion 75 is provided in a protruding manner at a position which is away from a bead heel 7h of an outer wall surface of the bead portion 71, and a ventilation groove 76 is provided in a concave manner in a surface of the bulge portion 75. Accordingly, as shown in FIG. 9, the bead portion 61 and the bead portion 71 are locally brought into contact with each other at a position which is away from the bead seat 8b, an annular air gap S continuing in a tire circumferential direction is provided between the bead heel 7h of the inner tire 7 and the bead toe 6t of the outer tire 6, and the air gap S and the air chamber 9B are communicated with each other by the ventilation groove 76, whereby the air can be fed in.

In U.S. Pat. No. 4,995,438 and U.S. Pat. No. 5,246,050, there is described a ventilation groove extending in parallel in a radial direction as mentioned above, and in U.S. Pat. No. 5,273,093, there is described a ventilation groove extending so as to be inclined with respect to a radial direction. In this case, in the latter, the ventilation groove is formed in an inner wall surface of a bead portion of an outer tire. In U.S. Pat. No. 6,688,359, there is described a ventilation groove extending in a lattice shape, and the ventilation groove has a component extending annularly in a tire circumferential direction at a position which is away from a bead heel.

Meanwhile, in this kind of pneumatic tire, it is necessary to first supply the air from the rim valve 81 so as to inflate only the inner tire 7 and next supply the air from the rim valve 82 so as to inflate the outer tire 6, at the time of assembling in the rim 8. This is because the positioning of both the bead portions 61 and 71 cannot be suitably performed unless the seating is performed while making the bead portion 71 of the inner tire 7 close to the outer side in a state in which the internal pressure of the outer tire 6 is close to zero. Particularly, in order to uniformly fit the bead portion 61 of the outer tire 6 to the rim flange 8a, it is necessary to uniformly and sufficiently press the bead portion 61 of the outer tire 6 by the bead portion 71 of the inner tire 7.

However, since the conventional pneumatic tire is structured such that the annular air gap S is provided by locally bringing the bead portion 71 of the inner tire 7 into contact with the bead portion 61 of the outer tire 6, it is impossible to strongly press the lower portion of the bead portion 61 of the outer tire 6 to the rim flange 8a. Accordingly, it is difficult to uniformly fit the bead portion 61 to the rim flange 8a, and the outer tire 6 tends to be installed to the rim 8 in an uneven attitude. Further, since the movement of the outer tire 6 is constrained by the inflation of the inner tire 7, an installation uniformity of the outer tire 6 cannot be improved even by filling the air in the air chamber 9B.

As mentioned above, in the conventional pneumatic tire, the installation of the outer tire 6 to the rim 8 tends to be uneven. As a result, there is a problem that the uniformity of the tire is deteriorated. On the other hand, when the bead portion 71 is made inscribed in the bead portion 61 in a close contact state, the uniformity of the tire is improved, however, there is a problem that the air cannot be filled in the air chamber 9B as already described. Accordingly, it is difficult to achieve the filling up of the air in the air chamber 9B together with the uniform installation of the outer tire 6.

Further, in the case where the ventilation groove has the component which continuously extends in the tire circumferential direction, such as the pneumatic tire described in U.S. Pat. No. 6,688,359, the portion having low rigidity is formed along the component, and change in the rigidity of the bead portion tends to become large. Accordingly, there is a risk that a stress is concentrated at the ventilation groove and the durability of the inner tire is thus weakened.

Each of the double structure tires described in Japanese Unexamined Patent Publication Nos. 49-063102, 49-111303, and 50-064902 is provided with a tire with a tube as the inner tire, and the air is filled in each of the air chambers via a tube valve provided in the inner tire and by properly using an adapter. Accordingly, these documents do not suggest a solution of the problem mentioned above.

### SUMMARY OF THE INVENTION

The present invention was made in view of the actual conditions described above, and an object of the present invention is to provide a pneumatic tire and a tire assembly body, in which an air can be filled in an air chamber formed at an outer side of an inner tire, and uniformity of a tire can be secured by enhancing installation uniformity of an outer tire.

The object can be achieved by the present invention having the following structure. The present invention provides a pneumatic tire comprising:

an outer tire installed such that a bead portion is made inscribed in a rim flange;

an inner tire inserted inside the outer tire and installed such that a bead portion is made inscribed in the bead portion of the outer tire; and

air chambers formed at an inner side and an outer side of the inner tire, wherein
a plurality of protrusions are provided in an annular outer side wall surface region extending in an outer side in a tire diametrical direction from a bead heel of the inner tire in such a manner as to be differentiated in the positions in the tire diametrical direction and overlap with one another as seen from a tire circumferential direction, and

a ventilation path for feeding an air supplied to a portion near the bead heel of the inner tire into the air chamber formed at the outer side of the inner tire is formed between the protrusions in a state where the outer side wall surface region of the inner tire is made inscribed in the bead portion of the outer tire.

In the pneumatic tire in accordance with the present invention, at the time of assembling in the rim, it is possible to make the annular outer side wall surface region extending in the outer side in the tire diametrical direction from the bead heel of the inner tire inscribed in the bead portion of the outer tire at the time of first inflating only the inner tire and seating while making the bead portion close to the outer side. In other words, the present invention is not structured such that the annular air gap is provided in the outside of the bead heel of the inner tire, as is different from the conventional structure. Further, the outer side wall surface region of the inner tire is provided with a plurality of protrusions arranged in such a manner as to be differentiated in the positions in the tire diametrical direction and overlap with one another as seen from the tire circumferential direction, and the plurality of protrusions come to be inscribed in the bead portion of the outer tire. Accordingly, it is possible to uniformly press the bead portion of the outer tire against the rim flange so as to perform the fitting by inflating the inner tire, whereby it is possible to enhance the installation uniformity of the outer tire to the rim.

Further, in accordance with the present invention, the ventilation path for feeding the air supplied to the portion near the bead heel of the inner tire to the air chamber formed at the outer side of the inner tire is formed between the protrusions in the state where the outer sidewall surface region of the inner tire is inscribed in the bead portion of the outer tire. Accordingly, it is possible to fill the air in the air chamber formed at the outer side of the inner tire in a state where the inner tire is inflated. As described above, in accordance with the present invention, it is possible to suitably fill the air in the air chamber formed at the outer side of the inner tire, and it is possible to secure the uniformity of the tire by enhancing the installation uniformity of the outer tire.

According to the present invention, since the plurality of protrusions are arranged so as to be differentiated in the positions in the tire diametrical direction and overlap with one another as seen from the tire circumferential direction, the ventilation path does not have any component extending continuously annularly in the tire circumferential direction. Accordingly, it is possible to reduce the change in rigidity at the bead portion of the inner tire, and it is possible to secure the durability of the inner tire.

In the structure mentioned above, it is preferable that a leading end of the protrusion is formed by a flat surface. In accordance with the structure described above, it becomes easy to uniformly bring the outer side wall surface region of the inner tire into contact with the bead portion of the outer tire, and it is possible to increase an effect of improving the installation uniformity of the outer tire. Further, it is possible to suppress a collapse of the protrusion when pressed against the bead portion of the outer tire, and it is possible to reliably secure the formation of the ventilation path.

In the structure mentioned above, it is preferable that the flat surface is formed in a circular shape. In accordance with the structure described above, it is easy to arrange the plurality of protrusions so as to be differentiated in the positions in the tire diametrical direction and overlap with one another as seen from the tire circumferential direction. Further, it is possible to prevent the stress from being concentrated at a local portion of the protrusion as much as possible when the protrusion is pressed against the bead portion of the outer tire.

In the structure mentioned above, it is preferable that the protrusion is formed in such a manner as to become thicker from the leading end toward the root. In accordance with the structure described above, since it is possible to increase the rigidity in the compressing direction of the protrusion so as to suppress the collapse caused when the protrusion is pressed against the bead portion of the outer tire, it is possible to reliably secure the formation of the ventilation path.

In the structure mentioned above, it is preferable that the inner tire includes a reinforcement fiber layer embedded inside the root of the protrusion. In accordance with the structure described above, since it is possible to increase the rigidity of the inside of the root of the protrusion so as to suppress the collapse caused when the protrusion is pressed against the bead portion of the outer tire, it is possible to reliably secure the formation of the ventilation path.

The present invention provides a tire assembly comprising:

a rim;

an outer tire installed to the rim such that a bead portion is made inscribed in a rim flange;

an inner tire inserted inside the outer tire and installed to the rim such that a bead portion is made inscribed in the bead portion of the outer tire; and

air chambers formed at an inner side and an outer side of the inner tire, wherein

a plurality of protrusions are provided in an annular outer side wall surface region extending in an outer side in a tire diametrical direction from a bead heel of the inner tire in such a manner as to be differentiated in the positions in the tire diametrical direction and overlap with one another in a tire circumferential direction, and

a ventilation path for feeding an air supplied from a rim valve at a position near the bead heel of the inner tire into the air chamber formed at the outer side of the inner tire is formed between the protrusions in a state where the outer side wall surface region of the inner tire is made inscribed in the bead portion of the outer tire.

The tire assembly is constituted by the tire assembly provided with the pneumatic tire in accordance with the present invention described above, and can achieve the functions and effects described above. In other words, it is possible to uniformly press the bead portion of the outer tire against the rim flange so as to carry out the fitting by inflating the inner tire, and it is possible to enhance the installation uniformity of the outer tire to the rim. Further, it is possible to fill the air in the air chamber formed at the outer side of the inner tire in the state where the inner tire is inflated.

### BRIEF DESCRIPTION OF THE DRAWINGS

FIG. 1 is a tire meridian cross sectional view at the time of installing a pneumatic tire in accordance with the present invention to a rim;

FIG. 2 is an enlarged view of a main portion of FIG. 1;

FIG. 3 is a perspective cross sectional view showing a bead portion of an inner tire;

FIG. 4 is a front view showing an outer side wall surface region of the bead portion of the inner tire;

FIG. 5 is a cross sectional view as seen from an arrow A-A in FIG. 4;

FIG. 6 is a front view showing an outer side wall surface region of a bead portion of an inner tire in accordance with another embodiment;

FIG. 7 is a front view showing an outer side wall surface region of a bead portion of an inner tire in accordance with another embodiment;

FIG. 8 is a tire meridian cross sectional view showing an example of a conventional pneumatic tire;

FIG. 9 is an enlarged view of a main portion of FIG. 8; and

FIG. 10 is a perspective cross sectional view showing a bead portion of an inner tire provided in the conventional pneumatic tire.

### DESCRIPTION OF REFERENCE NUMERALS

1 outer tire
2 inner tire
2h bead heel of inner tire
3A air chamber
3B air chamber
4 protrusion
5 reinforcement fiber layer
8 rim
8a rim flange
11 bead portion of outer tire
21 bead portion of inner tire
41 flat surface
81 rim valve
82 rim valve
WA outer side wall surface region

### DETAILED DESCRIPTION OF THE PREFERRED EMBODIMENTS

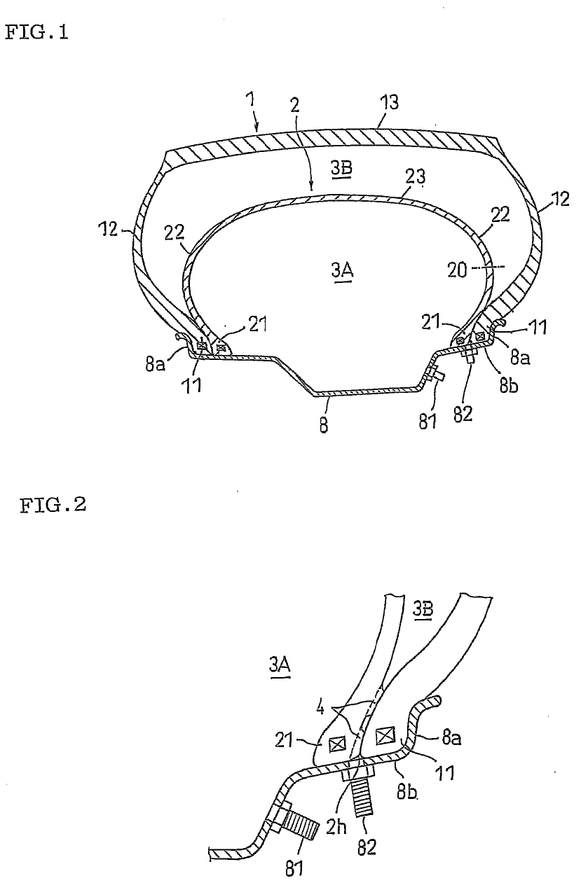

Description will be given below on embodiments in accordance with the present invention with reference to the accompanying drawings. FIG. 1 is a tire meridian cross sectional view at the time of installing a pneumatic tire in accordance with the present invention to a rim, and is also a tire meridian cross sectional view of a tire assembly in accordance with the present invention. FIG. 2 is an enlarged view of a main portion of FIG. 1.

The pneumatic tire has a double structure in which an inner tire 2 is inserted inside an outer tire 1. The outer tire 1 is constituted by a tubeless tire provided with a pair of bead portions 11, side wall portions 12 respectively extending in outer sides in a tire diametrical direction from the bead portions 11, and a tread portion 13 provided between the side wall portions 12. In the same manner, the inner tire 2 is constituted by a tubeless tire provided with a pair of bead portions 21, side wall portions 22 respectively extending in outer sides in the tire diametrical direction from the bead portions 21, and a tread portion 23 provided between the side wall portions 22.

The outer tire 1 is installed to a rim 8 while making the bead portion 11 mounted to a bead seat 8b inscribed in a rim flange 8a, and the inner tire 2 is installed to the rim 8 while making the bead portion 21 mounted to the bead seat 8b inscribed in the bead portion 11 of the outer tire 1. Further, an air chamber 3A is formed between the inner tire 2 and the rim 8, at an inner side of the inner tire 2, and an air chamber 3B is formed between the inner tire 2 and the outer tire 1, at an outer side of the inner tire 2. In the air chambers 3A and 3B, airtightness is independently secured, respectively.

It is possible to fill the air in the air chamber 3A from the rim valve 81 provided in the rim 8. On the other hand, it is possible to fill the air in the air chamber 3B from the rim valve 82 provided in the bead seat 8b of the rim 8, as will be described later in detail. In a state where the air is filled in both the air chambers 3A and 3B, the bead portion 11 is pressed against the rim flange 8a, and the bead portion 21 is pressed against the bead portion 11, whereby it is possible to fit both the tires 1 and 2 to the rim 8.

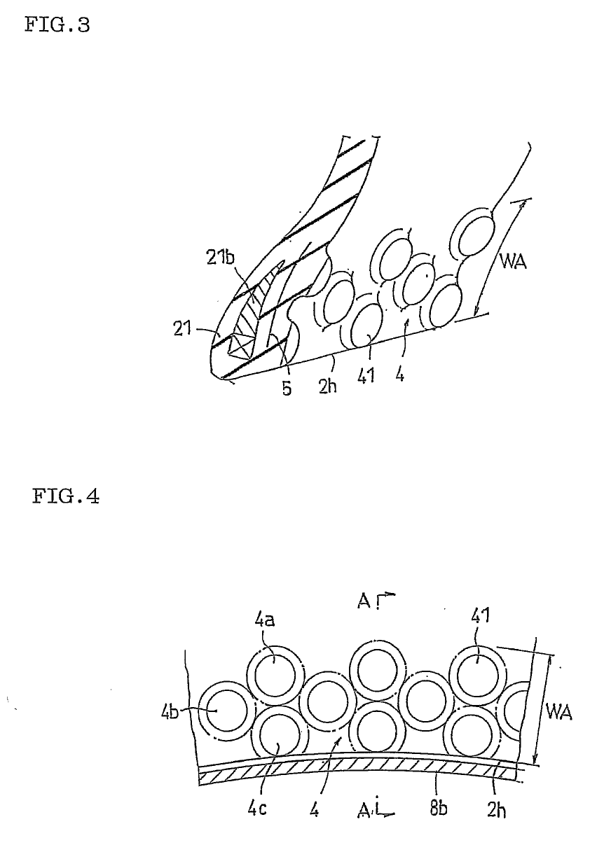

As shown in FIGS. 3 to 5, a plurality of protrusions 4 are provided in an annular outer wall surface region WA extending in an outer side in the tire diametrical direction from the bead heel 2h of the inner tire 2. A plurality of protrusions 4 are arranged so as to be differentiated in the positions in the tire diametrical direction and overlap with one another as seen from the tire circumferential direction. The outer side wall surface region WA may be structured, for example, so as to expand to a maximum width position 20 of the inner tire 2 from the bead heel 2h, as long as it is a region including a portion inscribed in the bead portion 11 of the outer tire 1.

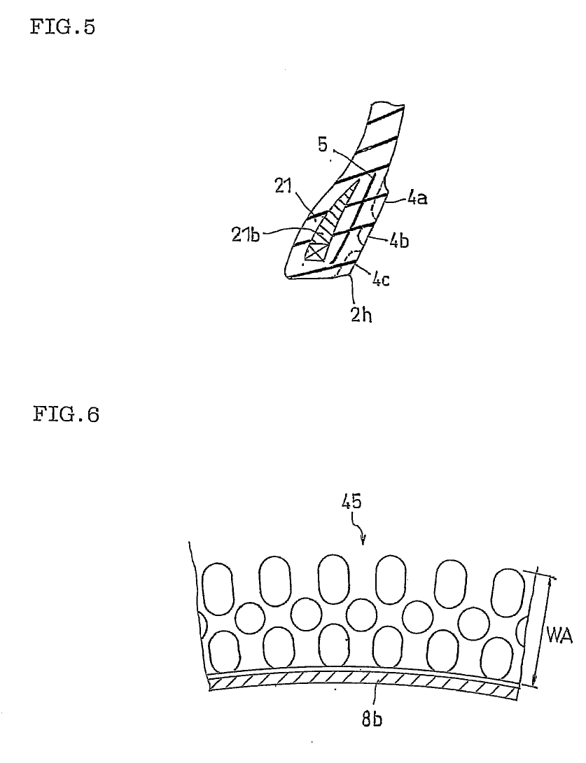

In the present embodiment, the protrusion 4 is arranged in plural stages, and more specifically, constituted by a stage including a protrusion 4a arranged near a leading end of a bead filler 21b, a stage including a protrusion 4b arranged inward in a tire diametrical direction from the protrusion 4a and overlapping with the protrusion 4a as seen from the tire circumferential direction, and a stage including a protrusion 4c arranged at a position reaching the bead head 2h at the inner side in the tire diametrical direction from the protrusion 4b and overlapping with the protrusion 4b as seen from the tire circumferential direction, as shown in FIGS. 4 and 5.

Further, the inner tire 2 is structured such that a ventilation path for feeding the air supplied to the portion near the bead heel 2h into the air chamber 3B is formed between the protrusions 4 in a state where the outer side wall surface region WA is inscribed in the bead portion 11. In other words, the plurality of protrusions 4 are arranged so as to be differentiated in the positions in the tire diametrical direction and overlapping with one another as seen from the tire circumferential direction as described above, while securing an interval at which the ventilation can be suitably obtained.

At the time of assembling the pneumatic tire in the rim 8, the air is first filled from the rim valve 81 so as to inflate only the inner tire 2 in the state where the outer tire 1 and the inner tire 2 are inserted outside the rim 8, and the seating is carried out by moving the bead portion 21 close to the outer side. The outer tire 1 at this time is in a state where the internal pressure is close to zero, and the bead portion 11 pressed outward by the bead portion 21 of the inner tire 2 is pressed against the rim flange 8a so as to be positioned.

In accordance with the present invention, since the plurality of protrusions 4 are provided in the outer side wall surface region WA, the annular air gap is not provided at the outside of the bead heel 2h of the inner tire 2, and the portion near the bead heel 2h of the inner tire 2 is inscribed in the bead portion 11 of the outer tire 1, as shown in FIG. 2. Accordingly, at the time of carrying out the seating of the bead portion 21, the fitting can be conducted by making the outer side wall surface region WA inscribed in the bead portion 11, and uniformly pressing the bead portion 11 against the rim flange 8a, and it is possible to increase the installation uniformity of the outer tire 1 to the rim 8.

Further, since the ventilation path for feeding the air supplied to the portion near the bead heel 2h into the air chamber 3B is formed between the protrusions 4 in the state where the outer side wall surface region WA is inscribed in the bead portion 11, it is possible to feed the air supplied from the rim valve 82 into the air chamber 3B after inflating the inner tire 2. As a result, it is possible to suitably fill the air in the air chamber 3B, and it is possible to enhance the installation uniformity of the outer tire 1 so as to secure the uniformity of the tire.

Further, since the plurality of protrusions 4 are arranged so as to be differentiated in the positions in the tire diametrical direction and overlap with one another as seen from the tire circumferential direction, the ventilation path does not have any component extending annularly continuously in the tire circumferential direction. Accordingly, it is possible to reduce the change in rigidity at the bead portion 21 of the inner tire 2, and it is possible to reliably secure the durability of the inner tire 2.

In accordance with the present invention, since the protrusions 4 as described above are provided in the outer side wall surface region WA of the bead portion 21 of the inner tire 2, an adverse affect is not given to the internal pressure holding of the outer tire 1, and it is possible to easily provide the protrusions 4 by applying a predetermined work to an inner surface of a metal mold for vulcanization molding of the inner tire 2. On the contrary, in the case where the ventilation path is formed by providing a protrusion in the inner wall surface of the bead portion 11 of the outer tire 1 or the like, it is impossible to employ adaptation by the metal mold and it becomes difficult to manufacture the tire.

In the present embodiment, the leading end of the protrusion 4 is formed by a flat surface 41. Accordingly, it is easy to uniformly bring the outer side wall surface region WA into contact with the bead portion 11 of the outer tire 1, and it is possible to increase an effect of improving the installation uniformity of the outer tire 1. Further, it is possible to suppress the collapse of the protrusion 4 pressed against the bead portion 11 of the outer tire 1, thereby it is possible to reliably secure the formation of the ventilation path.

It is preferable that the flat surface 41 of the protrusion 4 is formed in a circular shape, whereby it becomes easy to arrange the protrusions 4 so as to differentiate the positions thereof in the tire diametrical direction and overlap with one another as seen from the tire circumferential direction. Further, it is possible to prevent the stress from being concentrated at a local portion of the protrusion 4 as much as possible when the protrusion 4 is pressed against the bead portion 11. The “circular shape” includes an oval shape in addition to a perfect circle as in the present embodiment. A diameter of the flat portion 41 is not particularly limited, but is exemplified by 5 to 10 mm.

An interval and an arrangement density of the protrusions 4 is set such that the outer side wall surface region WA of the inner tire 2 is uniformly pressed against the bead portion 11 of the outer tire 1, and the ventilation path is formed in such a manner as to suitably fill the air in the air chamber 3B. Further, it is preferable that the height of the protrusion 4 is equal to or less than the diameter of the protrusion 4 (the diameter of the flat surface 41).

The protrusion 4 is formed in such a manner as to become thicker toward the root from the leading end, and the diameter thereof is gradually increased toward the root from the flat surface 41. Accordingly, since it is possible to increase the rigidity in the compressing direction of the protrusion 4 so as to suppress the collapse when the protrusion 4 is pressed against the bead portion 11 of the outer tire 1, it is possible to reliably secure the formation of the ventilation path. In this case, FIG. 4 shows an outline of the root of the protrusion 4 by a one-dot chain line.

The inner tire 2 in accordance with the present embodiment includes a reinforcement fiber layer 5 embedded inside the root of the protrusion 4. Accordingly, since it is possible to increase the rigidity of the inside of the root of the protrusion 4 so as to suppress the collapse when the protrusion 4 is pressed against the bead portion 11 of the outer tire 1, it is possible to reliably secure the formation of the ventilation path. As the reinforcement fiber layer 5, for example, a fabric material formed by plain weaving an organic fiber can be used.

The protrusion 4 may be provided in the outer side wall surface regions of the bead portions 21 on both sides, however, the present invention is not limited thereto, and the protrusion 4 may be provided at least in the outer side wall surface region WA of the bead portion 21 on the side mounted to the bead seat 8b provided with the rim valve 82.

The pneumatic tire and the tire assembly in accordance with the present invention can be structured in the same manner as the conventional one except that the protrusion as described above is provided in the inner tire 2 and the outer side wall surface region WA is made inscribed in the bead portion 11, and the conventional known materials, shapes, structures and the like can be adopted for the outer tire 1 and the inner tire 2.

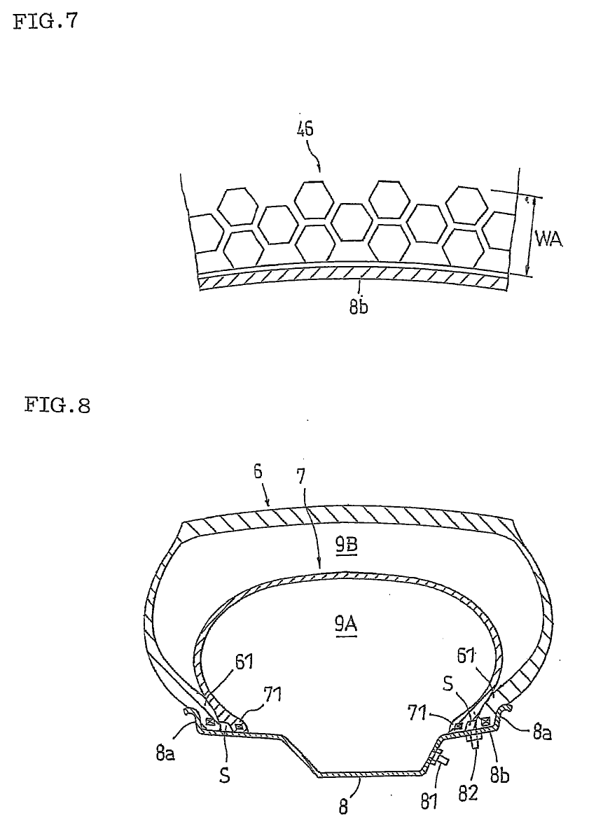

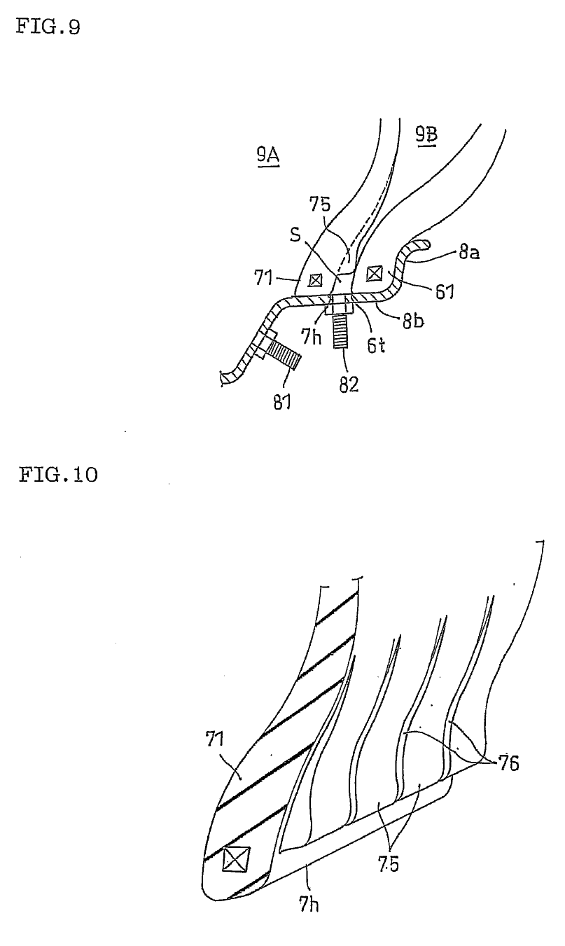

In the embodiment describled above, there is shown the example in which the protrusion provided in the inner tire is formed and arranged as shown in FIG. 4, however, the present invention is not limited thereto, and may be constituted by the structures illustrated in FIGS. 6 and 7. Although a protrusion 45 in FIG. 6 includes an oval shape, and a protrusion 46 in FIG. 7 is formed in a polygonal shape, both the protrusions are arranged in such a manner as to be differentiated in the positions in the tire diametrical direction and overlap with one another as seen from the tire circumferential direction, and the operations and effects described above can be achieved. Further, since these protrusions 45 and 46 overlap with one another as seen from the tire diametrical direction, the ventilation path is formed in a mesh shape and it is possible to more effectively reduce the change in rigidity of the bead portion.

What is claimed is:

1. A pneumatic tire comprising:
an outer tire installed such that a bead portion is made inscribed in a rim flange;
an inner tire inserted inside the outer tire and installed such that a bead portion is made inscribed in the bead portion of the outer tire; and
air chambers formed at an inner side and an outer side of the inner tire, wherein
a plurality of protrusions are provided in an annular outer side wall surface region extending in an outer side in a tire diametrical direction from a bead heel of the inner tire in such a manner as to be differentiated in the positions in the tire diametrical direction and overlap with one another as seen from a tire circumferential direction, and
a ventilation path for feeding an air supplied to a portion near the bead heel of the inner tire into the air chamber formed at the outer side of the inner tire is formed between the protrusions in a state where the outer side wall surface region of the inner tire is made inscribed in the bead portion of the outer tire.

2. The pneumatic tire according to claim 1, wherein a leading end of the protrusion is formed by a flat surface.

3. The pneumatic tire according to claim 2, wherein the flat surface is formed in a circular shape.

4. The pneumatic tire according to claim 1, wherein the protrusion is formed in such a manner as to become thicker from the leading end toward the root.

5. The pneumatic tire according to claim 1, wherein the inner tire includes a reinforcement fiber layer embedded inside the root of the protrusion.

6. A tire assembly comprising:
a rim;
an outer tire installed to the rim such that a bead portion is made inscribed in a rim flange;
an inner tire inserted inside the outer tire and installed to the rim such that a bead portion is made inscribed in the bead portion of the outer tire; and
air chambers formed at an inner side and an outer side of the inner tire, wherein
a plurality of protrusions are provided in an annular outer side wall surface region extending in an outer side in a tire diametrical direction from a bead heel of the inner tire in such a manner as to be differentiated in the positions in the tire diametrical direction and overlap with one another in a tire circumferential direction, and
a ventilation path for feeding an air supplied from a rim valve at a position near the bead heel of the inner tire into the air chamber formed at the outer side of the inner tire is formed between the protrusions in a state where the outer side wall surface region of the inner tire is made inscribed in the bead portion of the outer tire.

7. The tire assembly according to claim 6, wherein a leading end of the protrusion is formed by a flat surface.

8. The tire assembly according to claim 7, wherein the flat surface is formed in a circular shape.

9. The tire assembly according to claim 6, wherein the protrusion is formed in such a manner as to become thicker from the leading end toward the root.

10. The tire assembly according to claim 6, wherein the inner tire includes a reinforcement fiber layer embedded inside the root of the protrusion.
